(19) United States
(12) Patent Application Publication
(10) Pub. No.: US 2025/0085768 A1
(43) Pub. Date: Mar. 13, 2025

(54) OUTPUT DEVICE AND IMAGE FORMING APPARATUS

(71) Applicant: KYOCERA Document Solutions Inc., Osaka (JP)

(72) Inventor: Hitoshi MATSUMOTO, Osaka (JP)

(73) Assignee: KYOCERA Document Solutions Inc., Osaka (JP)

(21) Appl. No.: 18/580,303

(22) PCT Filed: Jul. 25, 2022
(86) PCT No.: PCT/JP2022/028594

§ 371 Date: Jan. 18, 2024

(30) Foreign Application Priority Data
Jul. 28, 2021 (JP) 2021-123467

(51) Int. Cl. G06F 1/3234; B41J 29/38; G06F 11/14; H04N 1/00

(52) U.S. Cl. CPC G06F 1/3284; B41J 29/38; G06F 11/1446; H04N 1/00896

(57) ABSTRACT

An image forming apparatus (1) includes: a USB connector (7) capable of being connected through a cable to a terminal device (40); a FIFO (24); and a control device (10) capable of functioning as a controller (100) that selectively executes one of a normal mode and a power-save mode. When receiving data sent through the cable from the terminal device (40) while executing the power-save mode, the controller (100) temporarily stores the data in the FIFO (24) to temporarily hold execution of processing according to the data, checks for the data stored in the FIFO (24) at predetermined second-scale time intervals, and executes the processing based on the data.

### TECHNICAL FIELD

The present invention relates to power saving of an output device of an image forming apparatus or the like.

### BACKGROUND ART

There is known an image forming apparatus, such as a printer, that receives data from a PC (personal computer) connected through a cable thereto and generates a printed matter from the data. There is also known an image forming apparatus that can selectively execute a plurality of operation modes (for example, a normal mode and a power-save mode) having different power consumptions. For example, an image forming apparatus is known that, upon receipt of a print instruction from a PC after transition to a power-save mode, transitions from the power-save mode from a normal mode and executes processing based on the print instruction to generate a printed matter.

Patent Literature 1 discloses a technique in which a printer connectable through a USB cable to a PC stores in a buffer an instruction received from the PC, then confirms, when a polling time comes, whether any instruction is stored in the buffer, and wakes up from a power-save mode upon confirmation of the instruction.

### CITATION LIST

### Patent Literature

### Patent Literature 1: JP-A-2011-051238

### SUMMARY OF INVENTION

Meanwhile, besides data significant to a user, such as a print instruction, data less significant to the user may be sent from the PC to the image forming apparatus. For example, the PC may periodically send, to an output device, data for confirming whether the PC is able to communicate with the image forming apparatus.

Even when receiving such data less significant to the user after the transition of the power-save mode, the image forming apparatus supplies power to a portion of a circuit to execute processing according to the received data. For example, the image forming apparatus returns a main memory from a power-saving state and sends response data responding to the received data to the PC. As a result, power is supplied to a portion of the circuit, which increases the power consumption.

Patent Literature 1 discloses a technique in which the printer stores in the buffer an instruction received from a PC and then checks the buffer for any instruction when a polling time comes. In other words, Patent Literature 1 discloses a technique for reducing the frequency of execution of processing for checking the buffer to thus save the power.

However, because the polling time is estimated to come on the millisecond timescale, the frequency of execution of the processing for checking the buffer is high and, therefore, the power-saving effect is not so high. In addition, a circuit of a polling timer for measuring the poling time has a higher operation speed than a circuit of a general timer for measuring time in seconds and, therefore, consumes a larger amount of power and shows a lower power-saving effect than the general timer.

The present invention has been made in view of the foregoing circumstances and has an object of enabling an output device capable of receiving data sent from a terminal device connected through a cable thereto to achieve further power saving during a power-save mode.

An output device according to an aspect of the present invention includes: a connector capable of being connected through a cable to a terminal device: a buffer; and a controller that selectively executes one of a normal mode and a power-save mode having a lower power consumption than the normal mode. When receiving data sent through the cable from the terminal device while executing the power-save mode, the controller temporarily stores the data in the buffer to temporarily hold execution of processing according to the data, checks for the data stored in the buffer at predetermined second-scale time intervals, and executes the processing based on the data.

An image forming apparatus according to another aspect of the present invention includes the above-described output device and an image forming device that forms an image on a recording medium.

### Advantageous Effects of Invention

In accordance with the present invention, data sent through the cable from the terminal device during execution of the power-save mode is temporarily stored in the buffer and processing according to the data is not immediately executed, but executed after being temporarily held. As a result, as compared to the case where the processing according to the data is immediately executed, the duration of time to consume less power can be increased and further power saving can be thus achieved. In addition, since the holding time is set not on the general millisecond timescale, but on the second timescale, the power-saving effect is high. Furthermore, because there is no need for a timer having a high operation speed (i.e., a timer having a large power consumption), even further power saving can be achieved.

When processing according to data sent from a terminal device is temporarily held, the execution of the processing is delayed, which may decrease the convenience. However, the holding is executed only in the power-save mode and not executed in the normal mode. Therefore, a large decrease in convenience can be prevented.

### BRIEF DESCRIPTION OF DRAWINGS

FIG. 1 is a functional block diagram schematically showing an essential internal configuration of an image forming apparatus according to a first embodiment.

FIG. 2 is a diagram schematically showing an example of an internal structure of an ASIC constituting part of a control device and surrounding parts of the ASIC.

FIG. 3 is a diagram for illustrating data flow in a normal mode.

FIG. 4A is a diagram for illustrating data flow when data is received in a power-save mode.

FIG. 4B is a diagram for illustrating data flow when processing according to data is executed in the power-save mode.

FIG. 5 is a flowchart showing data check processing.

FIG. 6 is a functional block diagram schematically showing an essential internal configuration of an image forming apparatus according to a second embodiment.

### DESCRIPTION OF EMBODIMENTS

### First Embodiment

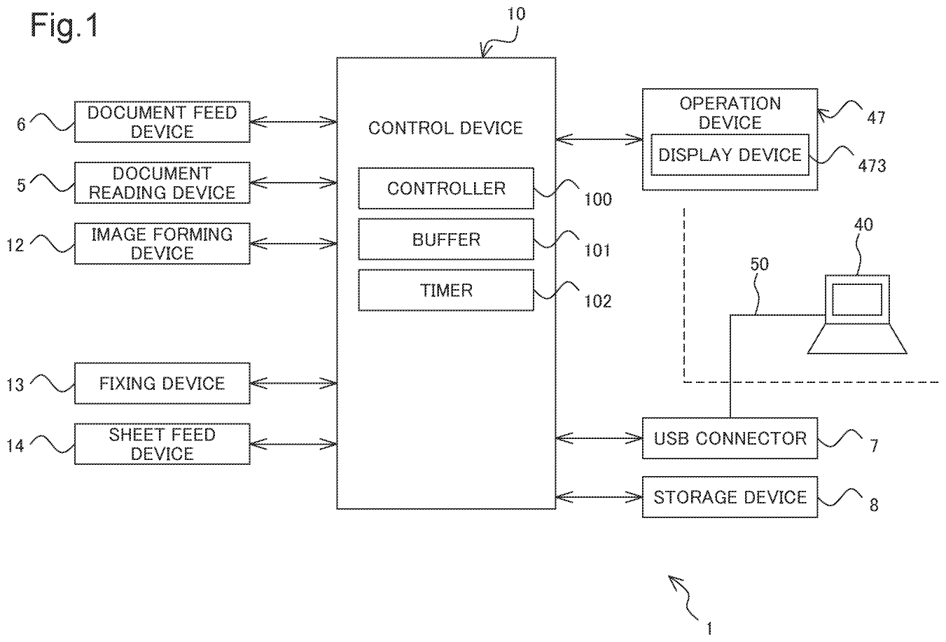

Hereinafter, a description will be given of an output device and an image forming apparatus according to an embodiment of the present invention with reference to the drawings. FIG. 1 is a functional block diagram schematically showing an essential internal configuration of an image forming apparatus 1 according to a first embodiment of the present invention. The image forming apparatus 1 is, for example, a multifunction peripheral having multiple functions, including a copy function, a print function, a scan function, and a facsimile function. The image forming apparatus 1 is an example of an output device defined in Claims.

The image forming apparatus 1 includes a control device 10, a document feed device 6, a document reading device 5, an image forming device 12, a fixing device 13, a sheet feed device 14, an operation device 47, a USD connector 7, and a storage device 8.

The document feed device 6 is capable of being opened and closed with respect to a top surface of the document reading device 5 by being mounted by hinges or the like on the top surface of the document reading device 5. The document feed device 6 functions as a document holding cover while an original document sheet placed on a platen glass is read. The document feed device 6 is an ADF (auto document feeder). The document feed device 6 includes a document loading tray and feeds original document sheets loaded onto the document loading tray to the document reading device 5.

First, a description will be given of the case where a document reading operation is performed on the image forming apparatus 1. The document reading device 5 optically reads an image of an original document sheet fed to the document reading device 5 by the document feed device 6 or an image of an original document sheet placed on the platen glass and generates image data on the original document sheet. The image data generated by the document reading device 5 is saved in an image memory or the like.

Next, a description will be given of the case where an image forming operation is performed on the image forming apparatus 1. Based on image data generated by the document reading operation, image data stored in the image memory or the like, image data received from a computer connected via a network or another image data, the image forming device 12 forms a toner image on a recording paper sheet as a recording medium fed from the sheet feed device 14.

The fixing device 13 applies heat and pressure to the recording paper sheet with the toner image formed thereon by the image forming device 12, thus fixing the toner image on the recording paper sheet. The recording paper sheet subjected to the fixation processing is discharged to a sheet output tray. The sheet feed device 14 includes a sheet feed cassette.

The operation device 47 accepts user's instructions for various types of operations and processing executable by the image forming apparatus 1, such as an instruction to execute an image forming operation. The operation device 47 includes a display device 473 that displays operation guidance and other types of information for the user. The operation device 47 accepts input of a user's instruction based on an operation (a touch gesture) of the user, through a touch panel provided on the display device 473, on the operation screen displayed on the display device 473 or based on an operation of the user on any of physical keys.

The display device 473 is formed of an LCD (liquid crystal display) or the like. The display device 473 is provided with the touch panel. When the user makes a touch gesture on a button or key being displayed on the screen, the touch panel accepts an instruction associated with a point where the touch gesture has been made.

The USB connector 7 is a connector for a USB through which the image forming apparatus 1 is to be connected to a terminal device 40, such as a PC, which is an external device. A USB cable 50 is connected to the USB connector 7. The image forming apparatus 1 performs data communication through the USB cable 50 with the terminal device 40.

The storage device 8 is a large storage device, such as an HDD (hard disk drive) or an SSD (solid state drive). The storage device 8 stores various control programs and others.

The control device 10 includes a processor, a RAM (random access memory), a ROM (read only memory), and a dedicated hardware circuit. The processor is, for example, a CPU (central processing unit), an ASIC (application specific integrated circuit) or an MPU (micro processing unit). The control device 10 includes a buffer 101 and a timer 102.

When the processor operates in accordance with a control program stored in the storage device 8, the control device 10 functions as a controller 100. However, the controller 100 may not be implemented by the operation of the control device 10 in accordance with the control program, but may be constituted by a hardware circuit. Hereinafter, the same applies to the other embodiments unless otherwise stated.

The controller 100 governs the overall operation control of the image forming apparatus 1. The controller 100 is connected to the document feed device 6, the document reading device 5, the image forming device 12, the fixing device 13, the sheet feed device 14, the operation device 47, the USB connector 7, and the storage device 8 and controls the operations of these components. For example, the controller 100 controls the operations of the image forming device 12 and other components involved to allow these components to form a document image represented by image data acquired by reading by the document reading device 5 on a recording paper sheet as a recording medium. According to a print instruction sent through the USB connector 7 from the terminal device 40, the controller 100 controls the operations of the image forming device 12 and other involved components to allow these components to form an image on a recording paper sheet as a recording medium.

The controller 100 selectively executes a plurality of modes (herein, a normal mode and a power-save mode) having different power consumptions. The normal mode is a mode for allowing the image forming apparatus 1 to perform operations by default where the consumed power is not reduced. The power-save mode is a mode for allowing the image forming apparatus 1 to perform operations with lower power consumption than in the normal mode.

The buffer 101 is formed of a FIFO (first-in first-out) memory or the like. When the power-save mode is being executed, the buffer 101 temporarily stores data sent through the USB cable 50 from the terminal device 40. The timer 102 is a general timer that measures time in seconds.

When being operating each of the operational components of the image forming apparatus 1 in the power-save mode, the controller 100 temporarily holds the execution of processing according to data sent from the terminal device 40. The controller 100 checks for data stored in the buffer 101, based on time measured by the timer 102, at predetermined second-scale time intervals T (for example, predetermined time intervals much longer than time intervals for use in checking whether data has come based on a polling timer) and executes processing according to the data. In other words, even when receiving data from the terminal device 40 while executing the power-save mode, the controller 100 does not start the execution of the processing according to the data immediately after the receipt of the data and delays the start of the execution.

The buffer 101 for use is a memory that has a sufficient capacity to accumulate data sent from the terminal device 40 within each of the time intervals T.

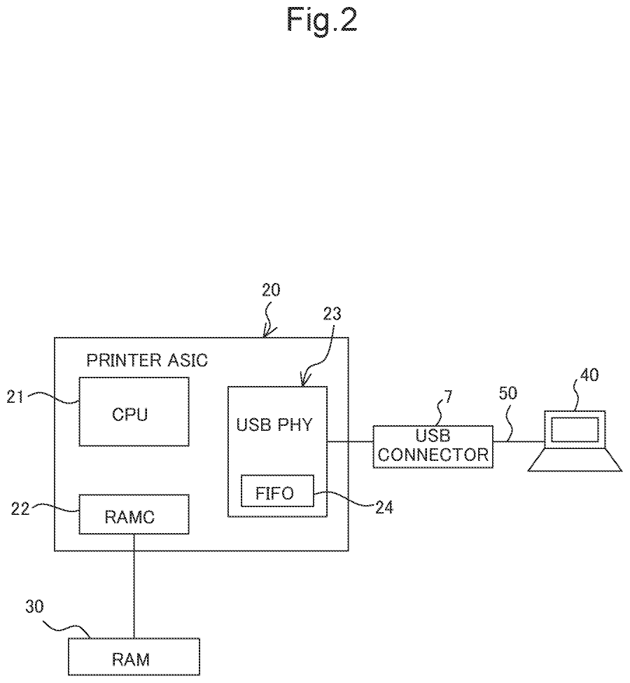

FIG. 2 is a diagram schematically showing an example of an internal structure of an ASIC constituting part of the control device 10 and surrounding parts of the ASIC. A printer ASIC 20 includes a CPU 21, a RAMC 22 serving as a memory controller, and a USB PHY (physical layer) 23.

The USB PHY 23 performs data communication (specifically, packet communication) with the terminal device 40 through the USB cable 50 connected to the USB connector 7. The USB PHY 23 includes a FIFO (first-in first-out) 24 as the buffer 101. For example, the USB PHY 23 converts an electric signal sent from the terminal device 40 into a digital signal and then outputs it to the CPU 21, the RAMC 22 or the FIFO 24. Furthermore, the USB PHY 23 converts a digital signal into an electric signal and then sends it to the terminal device 40. The data output to the RAMC 22 is, as necessary, transferred to a RAM 30 as a main memory.

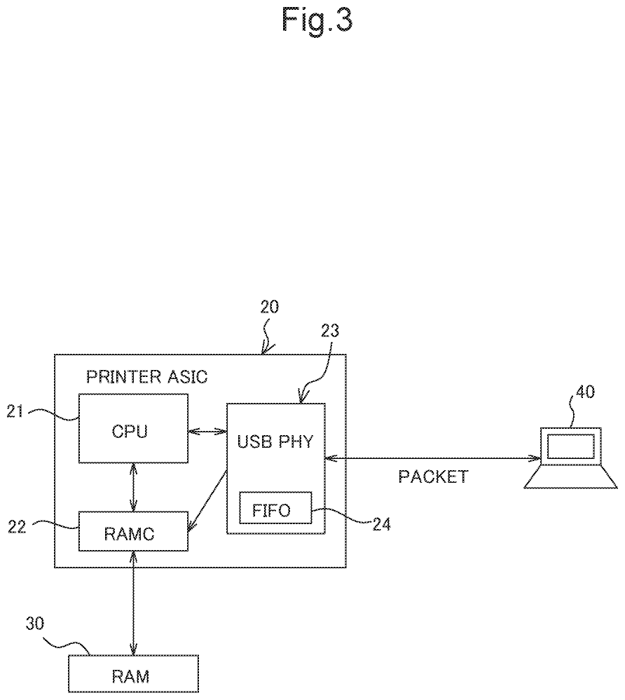

FIG. 3 is a diagram for illustrating data flow when the image forming apparatus 1 is in the normal mode. In the case where the image forming apparatus 1 is in the normal mode, when the USB PHY 23 receives data from the terminal device 40, the controller 100 (see FIG. 1), as necessary, allows the USB PHY 23 to output the received data to the CPU 21 or the RAMC 22 or send response data to the terminal device 40.

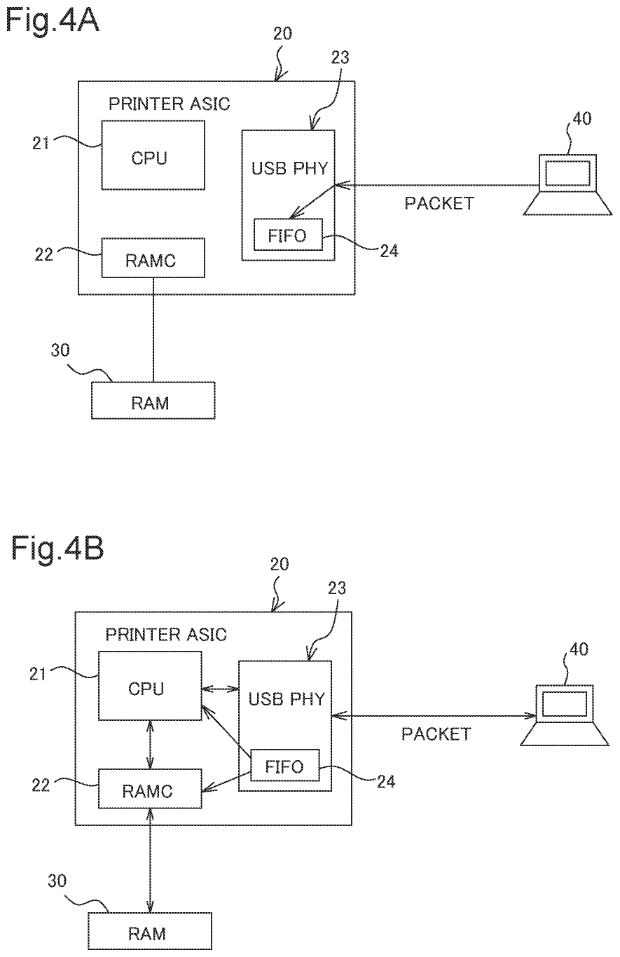

FIGS. 4A and 4B are diagrams for illustrating data flow when the image forming apparatus 1 is in the power-save mode. FIG. 4A shows a status when the USB PHY 23 receives data from the terminal device 40 and FIG. 4B shows a status when the controller 100 executes processing according to data stored in the FIFO 24.

In the case where the image forming apparatus 1 is in the power-save mode, when the USB PHY 23 receives data from the terminal device 40, the USB PHY 23 allows the FIFO 24 to store the received data as shown in FIG. 4A.

When transition from the normal mode to the power-save mode takes place, the controller 100 starts the timer 102. In the power-save mode, the controller 100 determines, at the predetermined time intervals T based on time measured by the timer 102, whether data is stored in the FIFO 24. When determining that data is stored in the FIFO 24, the controller 100 executes processing according to the data (i.e., predetermined processing to be executed for the data). For example, as shown in FIG. 4B, the controller 100, as necessary, allows the FIFO 24 to output data stored therein to the CPU 21 or the RAMC 22, allows the CPU 21 or the RAMC 22 to execute data processing or allows the USB PHY 23 to send response data to the terminal device 40.

Furthermore, the controller 100 determines whether it is necessary to execute processing according to data stored in the FIFO 24. When determining that it is necessary to execute the processing according to the data, the controller 100 executes the processing. On the other hand, when determining that it is not necessary to do it, the controller 100 avoids executing the processing. When the data stored in the FIFO 24 is a print instruction, the data contains print data and, therefore, has a certain amount of data. In other words, a small amount of data can be said to be data not requiring processing according to the data. Therefore, the controller 100 determines that, for example, data having a predetermined amount or larger amount of data is data requiring processing according to the data.

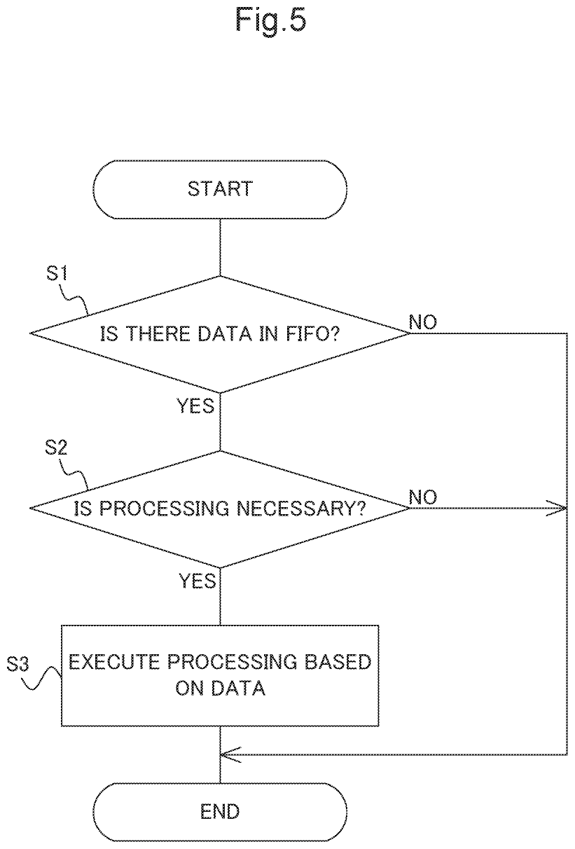

Next, a description will be given of data check processing of the controller 100 for checking for data stored in the FIFO 24, with reference to the flowchart shown in FIG. 5 and other figures. The controller 100 executes, in the power-save mode, the data check processing at the time intervals T measured by the timer 102.

The controller 100 determines whether or not data is stored in the FIFO 24 (step S1). When determining that data is stored in the FIFO 24 (YES in step S1), the controller 100 determines whether or not the data contains data requiring any processing (step S2). On the other hand, when determining that no data is stored in the FIFO 24 (NO in step S1), the controller 100 ends the data check processing.

When determining that the data contains data requiring any processing (YES in step S2), the controller 100 executes processing according to the data determined to require any processing (step S3) and then ends the data check processing. On the other hand, when determining that the data contains no data requiring any processing (NO in step S2), the controller 100 ends the data check processing.

In accordance with the first embodiment, data sent through the USB cable 50 from the terminal device 40 during execution of the power-save mode is temporarily stored in the FIFO 24 and the execution of processing according to the data is temporarily held. As a result, the duration of time to consume less power can be increased and further power saving can be thus achieved. In addition, since the holding time is set, not on the general millisecond (msec) timescale for use in checking whether data has come based on a polling timer, but on the second timescale as described above, the power-saving effect is high. Furthermore, since the time intervals T are predetermined time intervals much longer than general time intervals for use in checking whether data has come based on a polling timer, there is no need for a timer operating at high speed (i.e., a high power-consuming timer). Therefore, even further power saving can be achieved.

The controller 100 determines, based on the size of the amount of data, whether or not data stored in the FIFO 24 is data requiring processing, and executes the processing upon determination to be data requiring processing, but avoids executing the processing upon determination not to be data requiring processing. In other words, the controller 100 certainly and immediately executes processing to be immediately executed, but executes at the time intervals T processing not requiring immediate execution, thus preventing power from being wastefully supplied to the RAMC 22 or the RAM 30 to prevent the power consumption from being increased.

When processing according to data sent from the terminal device 40 is temporarily held, the execution of the processing is delayed, which may decrease the convenience. However, the holding is executed only in the power-save mode and not executed in the normal mode. Therefore, a large decrease in convenience can be prevented.

### Second Embodiment

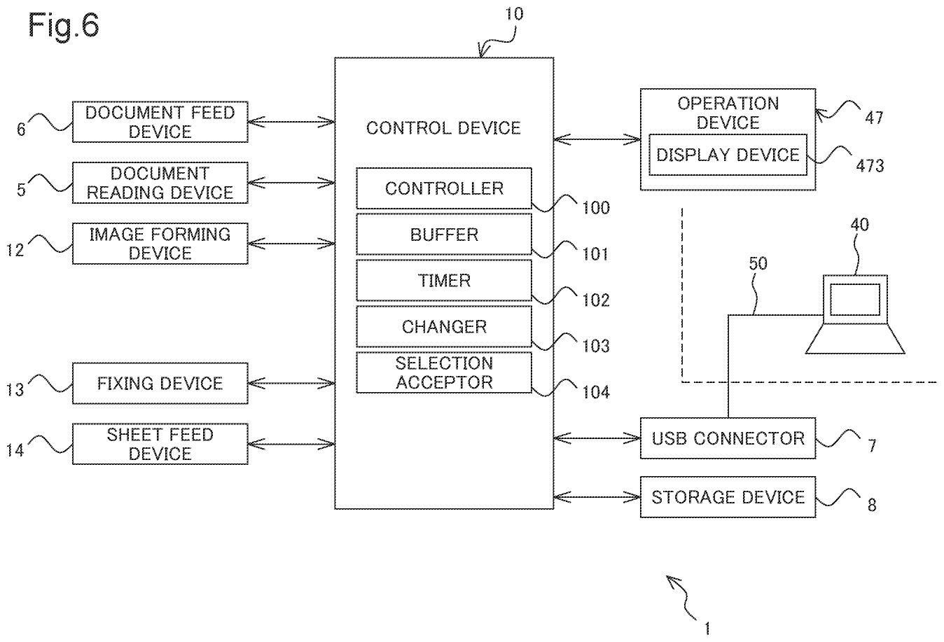

Next, a description will be given of an image forming apparatus 1 according to a second embodiment. FIG. 6 is a functional block diagram schematically showing an essential internal configuration of the image forming apparatus 1 according to the second embodiment. Further explanation of the same structures, configurations, and processing as in the first embodiment will be omitted from the description of the second embodiment. The image forming apparatus 1 according to the second embodiment is different, from the image forming apparatus 1 according to the first embodiment shown in FIG. 1, in that the control device 10 functions as a changer 103 and a selection acceptor 104.

When the processor operates in accordance with a control program stored in the storage device 8, the control device 10 functions as the controller 100, the changer 103, and the selection acceptor 104.

The changer 103 changes the length of the time interval T according to the environment of use of the image forming apparatus 1. For example, it can be expected that the frequency of use of the image forming apparatus 1 is high from 9 a.m. to 5 p.m. on weekdays. Therefore, the changer 103 shortens the time interval T during the above time zone and lengthens the time interval T during the other time zone. Thus, an apparatus well balanced between power saving and convenience can be achieved. For example, regarding the time zone when the time interval T is to be shortened and how much the time interval Tis to be shortened, the changer 103 follows a specified time zone and a specified value indicating how much the time interval T is to be shortened, each input to the operation device 47 by a user's operation.

The selection acceptor 104 accepts a user's selection of whether to enable or disable the function to temporarily hold the execution of processing according to data sent from the terminal device 40. The selection acceptor 104 accepts the user's selection, for example, through the operation device 47.

The controller 100 enables or disables the above function according to the user's selection accepted by the selection acceptor 104. Thus, a decrease in user convenience can be even further prevented.

### Third Embodiment

The terminal device 40 may have a timeout function. The timeout function is a function to terminate connection with the other end of data communication when there is no response from the other end despite the passage of a predetermined certain period of time. This function is originally based on the assumption that any trouble has occurred at the other end.

However, when, as described previously in the above embodiment, data sent from the terminal device 40 is temporarily stored in the FIFO 24 and the start of execution of processing according to the data is delayed by holding for the time interval T, the terminal device 40 may use the timeout function to terminate the connection with the image forming apparatus 1 even though no trouble occurs in the image forming apparatus 1. In this case, a mismatch occurs when the terminal device 40 receives response data sent from the image forming apparatus 1 after the passage of the time interval T, which may cause some kind of problem.

To cope with the above mismatch, in the image forming apparatus 1 according to a third embodiment, when processing according to data stored in the FIFO 24 is processing for sending response data responding to the data to the terminal device 40, the controller 100 sends, upon receipt of the data through the cable 50, information indicating that the data has been properly received, through the cable 50 to the terminal device 40. Thus, the occurrence of the above problem can be prevented. The structure and configuration of the image forming apparatus 1 according to the third embodiment may be those shown in the first embodiment or those shown in the second embodiment.

The terminal device 40 is previously provided with a function to deal appropriately with the above information. For example, the function is previously provided in a printer driver installed into the terminal device 40 in order to control the image forming apparatus 1.

### Fourth Embodiment

In the image forming apparatus 1 according to a fourth embodiment, at the time of transition to the power-save mode, the controller 100 sends, through the cable 50 to the terminal device 40, information indicating that the execution of processing according to data sent from the terminal device 40 is temporarily held. Thus, the occurrence of the above problem can be prevented. The structure and configuration of the image forming apparatus 1 according to the fourth embodiment may be those shown in the first embodiment or those shown in the second embodiment.

The terminal device 40 is previously provided with a function to deal appropriately with the above information. For example, like the case described in the third embodiment, the function is previously provided in a printer driver.

### Fifth Embodiment

In the image forming apparatus 1 according to a fifth embodiment, the controller 100 sets the length of the time interval T shorter than a timeout period before a timeout of the connection of the terminal device 40 with the image forming apparatus 1 occurs, the timeout period being set on the terminal device 40 side. For example, in the case of connection with a terminal device 40 where the timeout period is set at five seconds, the controller 100 sets the time interval T at less than five seconds. In the case of connection with a terminal device 40 where the timeout period is set at three seconds, the controller 100 sets the time interval T at less than three seconds. Thus, the occurrence of the above problem can be prevented. The structure and configuration of the image forming apparatus 1 according to the fifth embodiment may be those shown in the first embodiment or those shown in the second embodiment.

By taking the measures described in each of the third to fifth embodiments, appropriate power saving for the image forming apparatus I can be achieved regardless of the terminal device 40 serving as a host.

The present invention is not limited to the structures and configurations of the above embodiments and can be modified in various ways. Although the description in the above embodiments has been given using an image forming apparatus being a multifunction peripheral as an example of the output device according to the present invention, the image forming apparatus is merely illustrative. The output device according to the present invention may be any other type of output device, such as a printer, that performs output processing according to data received from the terminal device 40.

The structures, configurations, and processing of the above embodiments shown in FIGS. 1 to 6 are merely illustrative of the present invention and are not intended to limit the present invention to them.

1. An output device comprising:
a connector capable of being connected through a cable to a terminal device;
a buffer; and
a control device that includes a processor and functions, through the processor executing a control program, as a controller that selectively executes one of a normal mode and a power-save mode having a lower power consumption than the normal mode,
wherein when receiving data sent through the cable from the terminal device while executing the power-save mode, the controller temporarily stores the data in the buffer to temporarily hold execution of processing according to the data, checks for the data stored in the buffer at predetermined second-scale time intervals, and executes the processing based on the data.

2. The output device according to claim 1, wherein the controller determines, according to an amount of the data, whether or not it is necessary to execute processing based on the data stored in the buffer, and executes the processing upon determination that it is necessary to execute the processing, but avoids executing the processing upon determination that it is not necessary to execute the processing.

3. The output device according to claim 1, further comprising a changer that changes a length of the time interval according to environment of use of the output device.

4. The output device according to claim 3, wherein the changer shortens the time interval during a predetermined time zone during which a frequency of use of the output device is expected to be high, but lengthens the time interval during a time zone other than the predetermined time zone.

5. The output device according to claim 1,
further comprising an operation device to which a user's instruction is to be input,
wherein the control device further functions, through the processor executing the control program, as a selection acceptor that accepts through the operation device a user's selection of whether to enable or disable a function to temporarily hold the execution of processing according to the data sent from the terminal device, and
the controller enables or disables the function according to the user's selection accepted by the selection acceptor.

6. The output device according to claim 1, wherein when the processing according to the data is processing for sending response data responding to the data to the terminal device, the controller sends, upon receipt of the data through the cable, information indicating that the data has been properly received, through the cable to the terminal device.

7. The output device according to claim 1, wherein at a time of transition to the power-save mode, the controller sends, through the cable to the terminal device, information indicating that the execution of processing according to the data sent from the terminal device is temporarily held.

8. The output device according to claim 1, wherein the controller sets a length of the time interval shorter than a timeout period before a timeout of connection of the terminal device with the output device occurs, the timeout period being set on the terminal device side.

9. The output device according to claim 1, wherein
when an amount of the data is equal to or larger than a predetermined amount, the controller executes the processing according to the data, and
when the amount of the data is less than the predetermined amount, the controller avoids executing the processing.

10. An image forming apparatus comprising:
the output device according to claim 1; and
an image forming device that forms an image on a recording medium.
